(19) United States
(12) Patent Application Publication
(10) Pub. No.: US 2012/0323414 A1
(43) Pub. Date: Dec. 20, 2012

(54) HYBRID ELECTRIC VEHICLE

(76) Inventors: Wei-Hua Lu, Taipei (TW); Chih-Kuei Hu, Jubei (TW); Wei-Ting Liu, Hacienda Heights, CA (US)

(21) Appl. No.: 13/160,567

(22) Filed: Jun. 15, 2011

(51) Int. Cl. B60W 20/00; B60W 10/00

(52) U.S. Cl. 701/22; 180/65.21; 180/65.245; 180/65.285; 903/906; 903/907

(57) ABSTRACT

The present invention discloses a novel hybrid electric vehicle. The hybrid electric vehicle comprises a control module to control the charging operation according to at least one of the accelerating information, the speed information, or the gradient information of the vehicle, so as to charge the battery automatically.

### BACKGROUND OF THE INVENTION

1. Field of the Invention

The present invention relates to a hybrid electric vehicle, and more particularly, to a hybrid electric vehicle having a specific charging policy.

2. Description of the Prior Art

In nowadays, power saving strategy has become a new issue because of the very limited resources on the earth. Therefore, the concept of hybrid electric vehicle is introduced to reduce the power consumption. In simplicity, hybrid electric vehicle is available to use different driving strategies to drive the wheels. That is, when the vehicle starts to move, the vehicle can utilize its inner motor to drive the wheels, where the motor is activated by electricity. On the other hand, when the velocity of the vehicle is higher and steady, the vehicle can utilize the engine to drive the wheels, where the engine is activated by burning the gasoline. In this way, the hybrid electric vehicle can select a more efficient driving strategy in different conditions so that the hybrid electric vehicle can have a better power consumption performance.

The basic charging policy of a hybrid electric vehicle is to charge the battery when the brake is being activated. This means that the battery charging operation is accomplished by humans. However, human acts are not always reliable. For example, it may be a good time to charge the battery when the vehicle is on the slope, but the driver may not activate the brake so that the charging operation is not performed.

### SUMMARY OF THE INVENTION

It is therefore a primary objective of the claimed invention to provide to a hybrid electric vehicle having a specific charging policy, in order to solve the problem.

According to an objective of the present invention, a hybrid electric vehicle is disclosed. The hybrid electric vehicle comprises: an acceleration condition detector, for determining an acceleration condition of the hybrid electric vehicle; a battery; wheels; and a motor, for being driven by the wheels to generate power; wherein when the acceleration condition detector determines that the hybrid electric vehicle is decelerating, the motor is driven by the wheels to generate power to charge the battery.

According to an objective of the present invention, a hybrid electric vehicle is disclosed. The hybrid electric vehicle comprises: a gradient detector, for determining a gradient of the hybrid electric vehicle; a battery; wheels, a motor, for being driven by the wheels to generate power; wherein when the gradient is larger than a predetermined angle, the motor is driven by the wheels to generate power to charge the battery.

According to an objective of the present invention, a hybrid electric vehicle comprises: a vehicle speed sensor, for detecting a speed of the hybrid electric vehicle and generating a speed signal according to the speed; a battery; wheels; a motor, for being driven by the wheels to generate power; and a control module, for determining whether the hybrid electric vehicle is decelerating according to the speed signal generated by the vehicle speed sensor, and controlling the motor to be driven by the wheels to generate power to charge the battery if the hybrid electric vehicle is decelerating.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a hybrid electric vehicle according to a first embodiment of the present invention.

FIG. 2 depicts the power flow of the hybrid electric vehicle shown in FIG. 1 when the charging operation is being performed.

FIG. 3 is a diagram showing a hybrid electric vehicle according to a second embodiment of the present invention.

FIG. 4 is a diagram showing a hybrid electric vehicle according to a third embodiment of the present invention.

FIG. 5 is a diagram showing a hybrid electric vehicle according to a fourth embodiment of the present invention.

FIG. 6 is a diagram showing a hybrid electric vehicle according to a fifth embodiment of the present invention.

### DETAILED DESCRIPTION

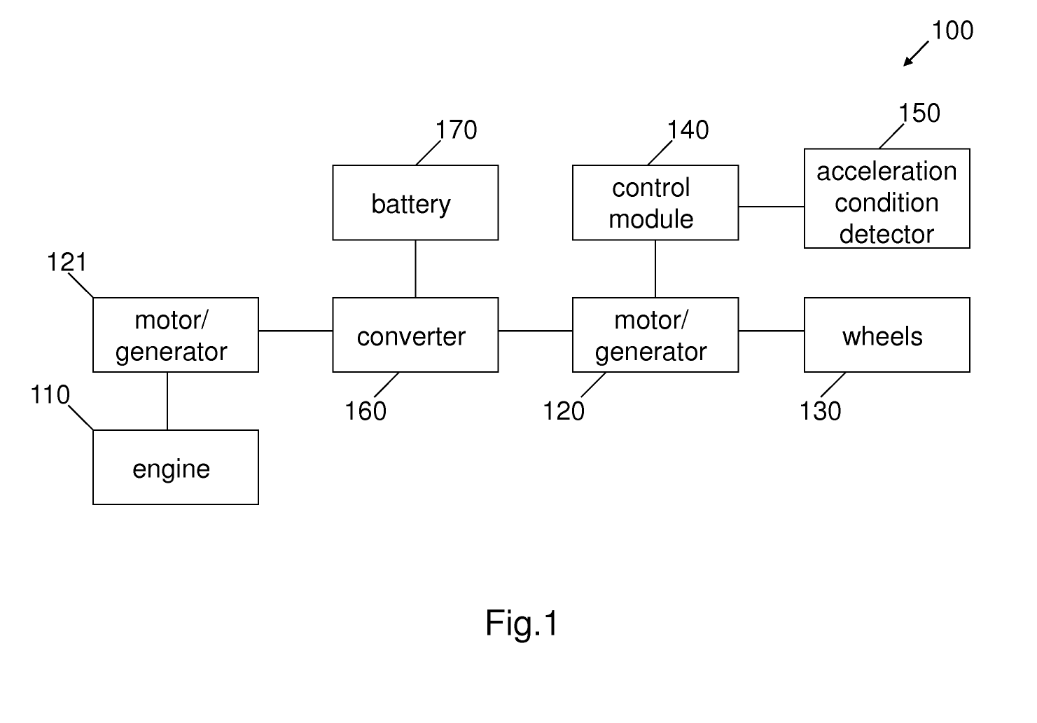

Please refer to FIG. 1, which is a block diagram of a hybrid electric vehicle 100 according to a first embodiment of the present invention. As shown in FIG. 1, the hybrid electric vehicle 100 comprises an engine 110, motor/generators 120/121, wheels 130, a control module 140, an acceleration condition detector 150, a converter 160, and a battery 170.

In this embodiment, the motor 120 is capable of generating electricity, which can be used to charge the battery 170 or to drive the wheels 130.

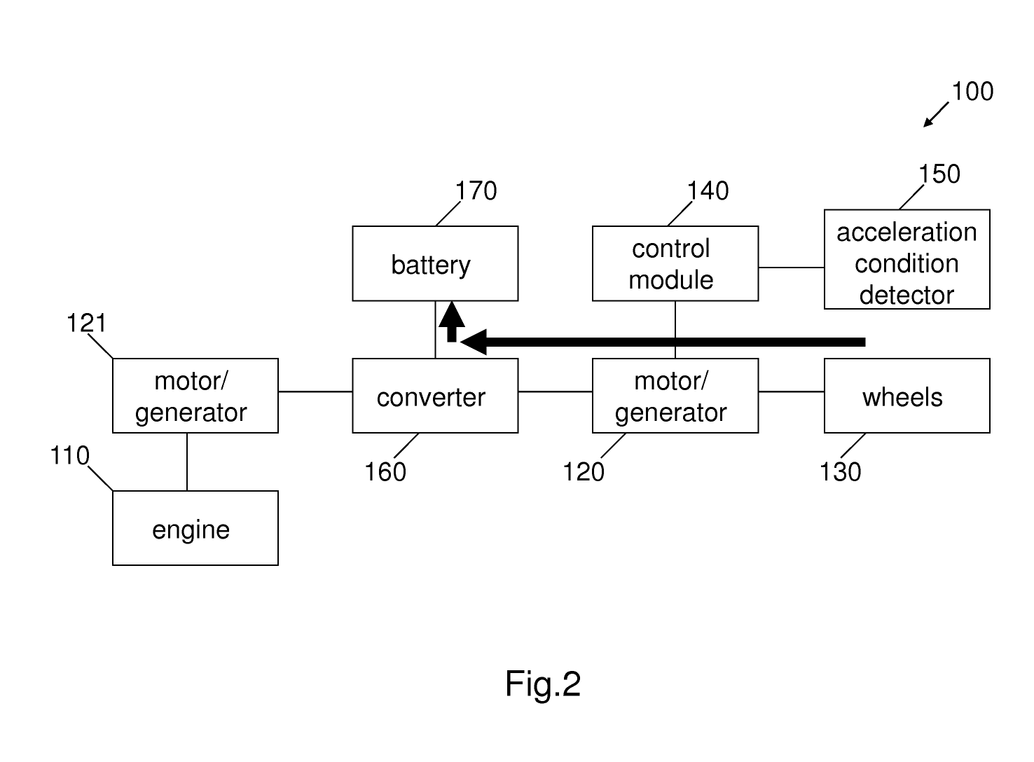

Please refer to FIG. 2, which depicts the power flow of the hybrid electric vehicle 100 when the charging operation is being performed. As shown in FIG. 2, it can be seen that power is flowed from the wheels 130 to the battery 170. That is, the motor/generator 120 is driven by the wheels 130 to generate electricity. And the generated electricity will be converted by the converter 160 and then stored into the battery 170. The connection relationships among those components are shown in FIG. 1, and thus further illustration are omitted for simplicity.

Please note, in this embodiment, the present invention does not trigger the charging operation according to the activation of the brake. Instead, the present invention has its own mechanism to determine when to trigger the charging operation.

Please refer to FIG. 2 again, in this embodiment, the control module 140 and the acceleration condition detector 150 are used to determine when to trigger the charging operation. That is, the acceleration condition detector 150 detects an acceleration condition of the vehicle 100. If the acceleration condition detector 150 determines that the vehicle 100 is decelerating, the acceleration condition detector 150 sends a signal to the control module 140. And then, the control module 140 triggers the charging operation according to the signal sent from acceleration condition detector 150 such that the motor/generator 120 is driven by the wheels 130 to generate electricity and the battery 170 is charged by the electricity.

Please note, the present invention does not limit the implementation of the acceleration condition detector 150. In a preferred embodiment, the acceleration condition detector can be implemented with an accelerometer (G sensor) or GPS device. For example, the vehicle 100 may have an embedded accelerometer or an embedded GPS device. It is well known that the accelerometer can obtain the acceleration information. Therefore, the accelerometer can obtain the acceleration information, and output the acceleration information to the control module 140. It is not hard for one having ordinary skills in the art to implement the GPS device as the acceleration condition detector. As is known, the GPS device is able to obtain the current speed of the vehicle. Therefore, as long as the GPS can obtain the speed variance between two different time spots, the acceleration information can be calculated by dividing the speed variance by the time difference. And then, the acceleration information is outputted to the control module 140.

And then, the control module 140 can trigger the charging operation when the acceleration information reveals that the vehicle 100 is decelerating.

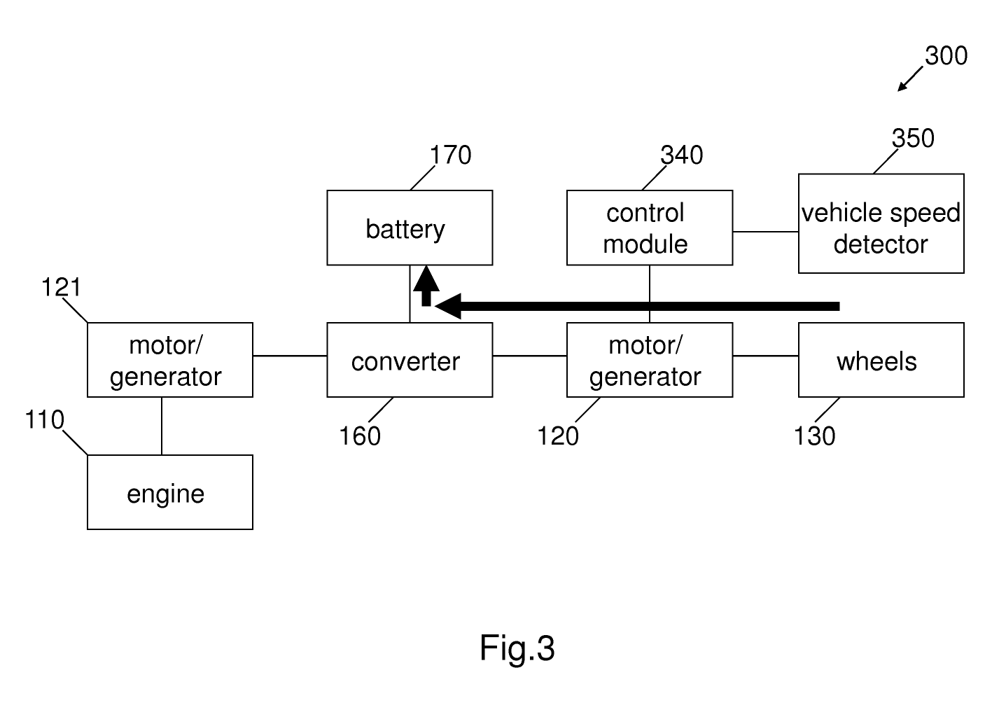

Please refer to FIG. 3, which is a diagram showing a hybrid electric vehicle 300 according to a second embodiment of the present invention. This embodiment is quite similar to the first embodiment, and the difference between them is that the acceleration condition detector 150 is replaced by a vehicle speed sensor 350.

The vehicle speed sensor 350 is used to determine the current speed of the hybrid electric vehicle 300, and send the speed information to the control module 340. The control module 340 can determine whether the hybrid electric vehicle 300 is decelerating according to the speed information, and trigger the charging operation when the vehicle 300 is decelerating.

Please note, the present invention does not limit the type of the speed sensor 350. This means that all devices capable of detecting the current speed can be implemented as the speed sensor 350 in the present invention. For example, a wheel speed sensor can be used as the vehicle speed sensor 350 of the present invention. Or, a speed indicator is often embedded inside a vehicle for indicating the current speed to the driver. This speed indicator can be also used as the vehicle speed sensor 350 of the present invention. Furthermore, the GPS device can also be used as the vehicle speed sensor 350.They are all capable of providing the speed information to the control module 340 so as to further control the charging operation.

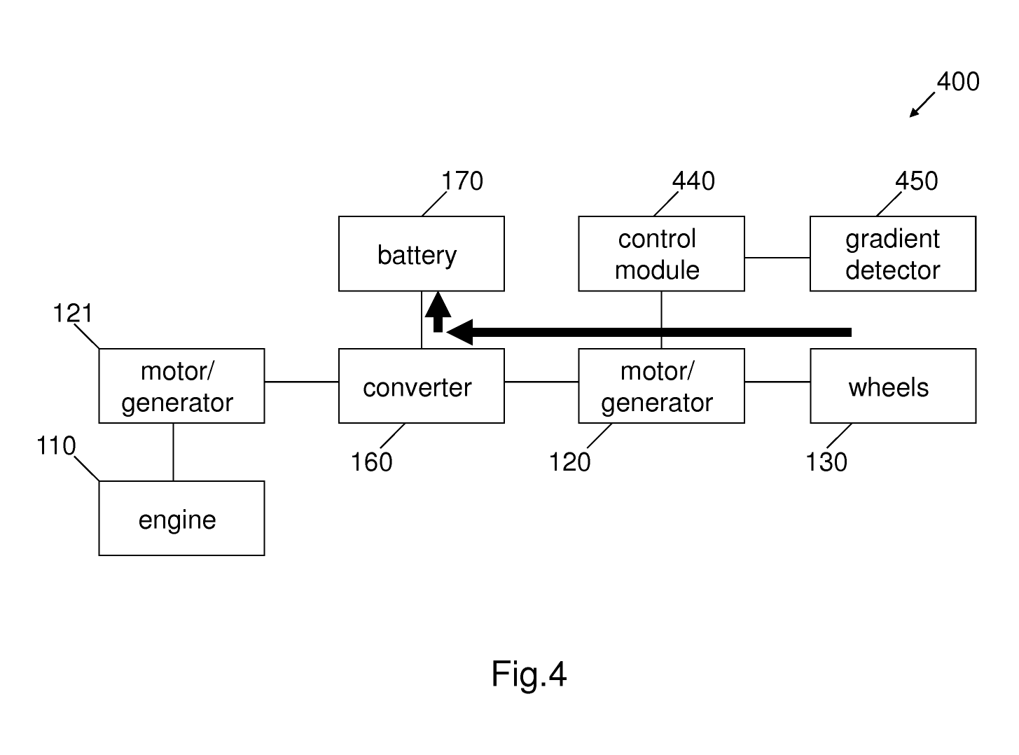

Please refer to FIG. 4, which is a diagram showing a hybrid electric vehicle 400 according to a third embodiment of the present invention. As shown in FIG. 4, in this embodiment, the hybrid electric vehicle 400 comprises a gradient detector 450 and a control module 440.

The gradient detector 450 is used to detect the gradient of the vehicle 400, and send the gradient information to the control module 440. The control module 440 controls the motor according to the gradient information. In a preferred embodiment, if the gradient is larger than a predetermined angle (ex: 5 degrees), the control module 440 controls the motor to be driven by the wheels to generate electricity such that electricity can be stored into the battery 170.

For example, the gradient detector 450 can detect whether the gradient is larger than a predetermined angle, and sends a signal to the control module 440 if the gradient is larger than the predetermined angle. Therefore, the control module 440 can control the motor to generate power according to the signal sent from the gradient detector 450 such that the generated power can be then stored into the battery 170.

Please note, the present invention does not limit the type of the gradient detector 450. As long as a device is able to provide the gradient information to the control module, this device is available for being used as the gradient detector 450. For example, the gradient detector 450 can be implemented with an accelerometer (G sensor). A 3-axis G sensor can be used to measure the horizontal acceleration and vertical acceleration. Therefore, the 3-axis G sensor can be used to calculate the gradient where the vehicle 400 is, and the gradient information generated by the 3-axis G sensor can be further utilized for the charging control.

As mentioned previously, the gradient detector 450 can be accomplished by a device capable of providing the current gradient information of the vehicle 400. For instance, an barometer may be used as the gradient detector 450. As is known, the air pressure is related to the height. It means that the barometer can detect the current height of the vehicle. Therefore, the height variance between two time spots can also be detected by the barometer. And the gradient information can be calculated by dividing the height variance by the time difference. In addition, the current gradient information is not necessary to be generated by measurement. In other words, if the gradient information has been recorded previously inside a database, the gradient information can be searched from the database according to the current location of the vehicle 400. This kind of database and related searching machine can be regarded as the above-mentioned gradient detector 450 of the present invention as well.

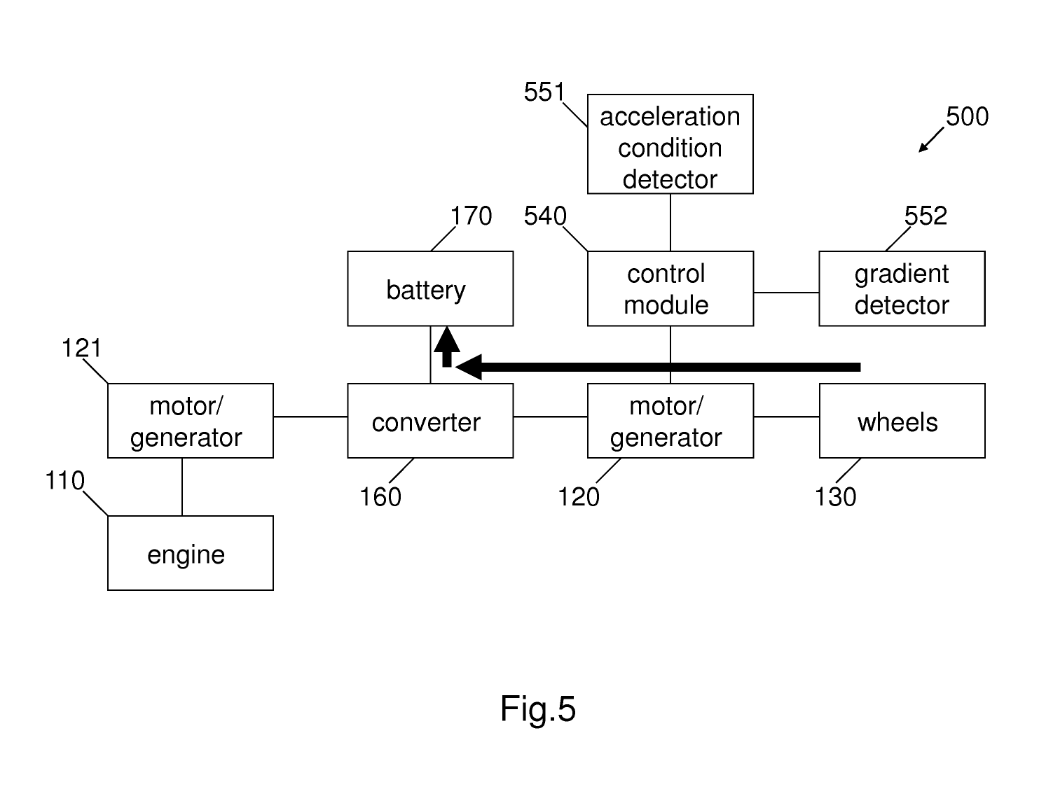

Please refer to FIG. 5, which is a diagram showing a hybrid electric vehicle 500 according to a fourth embodiment of the present invention. As shown in FIG. 5, the hybrid electric vehicle 500 comprises the acceleration condition detector 551, the gradient detector 552, and the control module 540.

In this embodiment, the control module 540 controls the motor 120 to generate power according to not only the acceleration information provided by the acceleration condition detector 551, but the gradient information provided by the gradient detector 552. In a preferred embodiment, if the acceleration information indicates that the vehicle 500 is decelerating or the gradient information indicates that the gradient of the vehicle is larger than a predetermined angle, the control module 540 controls the motor 120 to be driven by wheels 130 to generate electricity such that the electricity can be stored into the battery 170.

From the above, the acceleration condition detector 551 and the gradient detector 552 seems to be two separate devices. Please note, this is only an embodiment, not a limitation of the present invention. In the actual implementation, the acceleration condition detector 551 and the gradient detector 552 can be integrated into only one device. As mentioned previously, a 3-axis G sensor can provide the gradient information, and obviously, it can provide the acceleration condition information, also. Therefore, the acceleration condition detector 551 and the gradient detector 552 can be accomplished by only one device, the 3-axis G sensor. This means that the hybrid electric vehicle 500 can only comprise the 3-axis G sensor and the control module 540 such that the charging operation can be automatically controlled according to both the gradient condition and the acceleration condition of the vehicle 500.

In addition to the above-mentioned 3-axis G sensor, the GPS device may provide similar functions. There is no doubt the GPS device can provide acceleration information or the current speed information of the vehicle 500. Moreover, the GPS device can provide the current location of the vehicle 500, also. Therefore, as long as the gradient information of the entire map has been recorded into the database of the GPS device, the GPS device can search the gradient information of the current location of the vehicle from the database. In this way, the GPS device can provide both the gradient information and the acceleration condition information/speed information to the control module 540. Therefore, the control module 540 can also control the motor 120 to generate power according to the acceleration condition information/speed information and the gradient information provided by the GPS device.

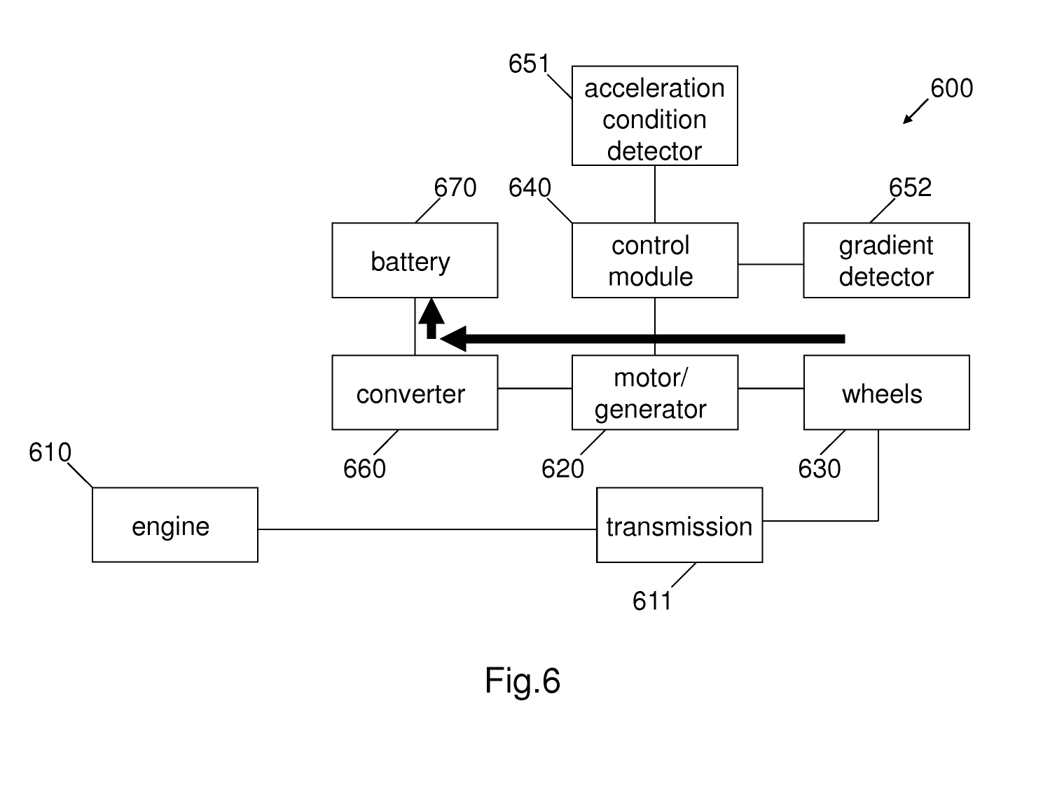

Please note, in the above-mentioned embodiments, the configuration of the hybrid electric vehicle is implemented with a series-type hybrid configuration. But this is not a limitation of the present invention. In the actual implementation, the present invention charging mechanism can be used in parallel-type hybrid configuration or split-type hybrid configuration. These changes also obey the spirit of the present invention. Please refer to FIG. 6, which is a hybrid electric vehicle 600 according to a fifth embodiment of the present invention.

In FIG. 6, the hybrid electric vehicle 600 is embodied in a parallel-type hybrid configuration. As is shown in FIG. 6, the engine 610 is no longer connected to the motor/generator. Instead, the engine 610 is connected to a transmission module 611, to transmit the power generated by the engine 610 to directly drive the wheel 630. Moreover, the power stored in the battery 670 can also be used for driving the wheel 630, just like the series-type hybrid configuration.

In this embodiment, similar to the above-mentioned embodiments, the control module 640 determines whether to charge the battery 670 (the charging path is depicted as the black arrow) according to the gradient information provided by the gradient detector 652 and/or the acceleration condition information provided by the acceleration condition detector 651. Therefore, in this embodiment, the charging operation is determined by the control module 640 according to the condition of the vehicle 600 automatically. Please note, the charging mechanism has been illustrated in the previous illustration and thus omitted here.

In contrast to the prior art, the charging operation is automatically controlled by the control module according to at least one of the acceleration information, the current speed information, and gradient information instead of the conventional manually-controlled charging operation. Furthermore, the hybrid electric vehicle can only comprise a G sensor or a GPS device to provide the above-mentioned acceleration information, the current speed information, and gradient information. Sometimes, the G sensor or the GPS device has been embedded inside a normal vehicle. This means that the present invention can utilize an ordinary device of the vehicle, such that the present invention does not require too much cost to implement those devices.

Those skilled in the art will readily observe that numerous modifications and alterations of the device and method may be made while retaining the teachings of the invention.

What is claimed is:

1. A hybrid electric vehicle comprising:
an acceleration condition detector, for determining an acceleration condition of the hybrid electric vehicle;
a battery;
wheels; and
a motor, for being driven by the wheels to generate power;
wherein when the acceleration condition detector determines that the hybrid electric vehicle is decelerating, the motor is driven by the wheels to generate power to charge the battery.

2. The hybrid electric vehicle of claim 1, wherein the acceleration condition detector is an accelerometer.

3. The hybrid electric vehicle of claim 2, further comprising:
a control module, coupled to the accelerometer and the motor, for controlling the motor according to the acceleration condition determined by the accelerometer.

4. The hybrid electric vehicle of claim 3, wherein the accelerometer generates a signal to the control module when determining that the hybrid electric vehicle is decelerating, and the control module controls the motor to generate power to charge the battery according to the signal.

5. The hybrid electric vehicle of claim 3, wherein the accelerometer further determines a gradient of the hybrid electric vehicle, and the control module controls the motor according to both the acceleration condition and the gradient determined by the accelerometers.

6. The hybrid electric vehicle of claim 1, wherein the acceleration condition detector is a GPS.

7. The hybrid electric vehicle of claim 6, further comprising:
a control module, coupled to the GPS and the motor, for controlling the motor according to the acceleration condition determined by the GPS;
wherein the GPS generates a signal to the control module when determining that the hybrid electric vehicle is decelerating, and the control module controls the motor to generate power to charge the battery according to the signal.

8. The hybrid electric vehicle of claim 1, further comprising:
a gradient detector, for determining a gradient of the hybrid electric vehicle, the motor is driven by the wheels to generate power to charge the battery when the gradient is larger than a predetermined angle or the hybrid electric vehicle is decelerating.

9. A hybrid electric vehicle comprising:
a gradient detector, for determining a gradient of the hybrid electric vehicle;
a battery;
wheels,
a motor, for being driven by the wheels to generate power;
wherein when the gradient is larger than a predetermined angle, the motor is driven by the wheels to generate power to charge the battery.

10. The hybrid electric vehicle of claim 9, wherein the acceleration condition detector is an accelerometer.

11. The hybrid electric vehicle of claim 10, further comprising:
a control module, coupled to the accelerometer and the motor, for controlling the motor according to the gradient determined by the accelerometer.

12. The hybrid electric vehicle of claim 11, wherein the accelerometer generates a signal to the control module when determining that the gradient is larger than a predetermined angle, and the control module controls the motor to generate power to charge the battery according to the signal.

13. The hybrid electric vehicle of claim 9, wherein the acceleration condition detector is a GPS device.

14. The hybrid electric vehicle of claim 13 further comprising:
a control module, coupled to the GPS device and the motor, for controlling the motor according to the gradient determined by the accelerometer;

15. The hybrid electric vehicle of claim 14, wherein the GPS device generates a signal to the control module when determining that the gradient is larger than a predetermined angle, and the control module controls the motor to generate power to charge the battery according to the signal.

16. The hybrid electric vehicle of claim 9, wherein the acceleration condition detector is an barometer.

17. A hybrid electric vehicle comprising:
a vehicle speed sensor, for detecting a speed of the hybrid electric vehicle and generating a speed signal according to the speed of the hybrid electric vehicle;
a battery;
wheels;
a motor, for being driven by the wheels to generate power; and
a control module, for determining whether the hybrid electric vehicle is decelerating according to the speed signal generated by the vehicle speed sensor, and controlling the motor to be driven by the wheels to generate power to charge the battery if the hybrid electric vehicle is decelerating.

18. The hybrid electric vehicle of claim 17, wherein the vehicle speed sensor is a GPS device.

19. The hybrid electric vehicle of claim 18 further comprising:
a control module, coupled to the GPS device and the motor, for controlling the motor according to the speed signal generated by the GPS device;
wherein the control module determines that the hybrid electric vehicle is decelerating according to the speed signal generated by the GPS device, the control module controls the motor to generate power to charge the battery according to the signal.

20. The hybrid electric vehicle of claim 19, wherein the vehicle speed sensor is a wheel speed sensor or a speed indicator.
